(19) United States
(12) Patent Application Publication
(10) Pub. No.: US 2026/0077452 A1
(43) Pub. Date: Mar. 19, 2026

(54) CLAMP JIG

(71) Applicant: PILLAR CORPORATION, Osaka (JP)

(72) Inventors: Tomohiro Adachi, Osaka (JP); Yuto Tsuchiya, Osaka (JP)

(73) Assignee: PILLAR CORPORATION, Osaka (JP)

(21) Appl. No.: 19/109,206

(22) PCT Filed: Sep. 6, 2023
(86) PCT No.: PCT/JP2023/032446

§ 371 Date: Mar. 6, 2025

(30) Foreign Application Priority Data
Oct. 27, 2022 (JP) 2022-172338

(51) Int. Cl. B25B 5/14; B25B 5/04

(52) U.S. Cl. CPC B25B 5/147; B25B 5/04

(57) ABSTRACT

A clamp jig includes: a fixed clamp having a fixed holding groove into which a part in a circumferential direction of a pipe is fitted; a movable clamp having a movable holding groove into which another part in the circumferential direction of the pipe is fitted to sandwich the pipe between the fixed holding groove and the movable holding groove, the movable clamp being provided so as to be movable with respect to the fixed clamp; and a tightening mechanism configured to pull the movable clamp toward the fixed clamp such that a bottom portion of the movable holding groove presses the pipe radially inward, in a state where the pipe is sandwiched between the fixed holding groove and the movable holding groove.

### TECHNICAL FIELD

The present invention relates to a clamp jig.

### BACKGROUND ART

In manufacturing processes in various technical fields such as semiconductor manufacturing, medical/pharmaceutical manufacturing, and food processing/chemical industries, in a pipe path through which fluids such as chemical solutions, high-purity liquids, ultrapure water, or cleaning solutions flow, for example, a pipe joint made of a synthetic resin is used to connect flow passages formed in tubes or fluid devices (see, for example, PATENT LITERATURE 1). This pipe joint includes an inner ring press-fitted into an end portion of a tube, a cylindrical joint body mounted on the outer circumferential side of the end portion of the tube, and a union nut mounted on the outer circumferential side of the joint body.

For example, a clamp jig described in PATENT LITERATURE 2 is known as a jig for holding a tube such that the tube does not slip when press-fitting an inner ring into an end portion of the tube. The clamp jig of PATENT LITERATURE 2 includes a fixed clamp, a movable clamp that is movable with respect to the fixed clamp, and a tightening mechanism (forced holding mechanism) that pulls the movable clamp toward the fixed clamp.

The fixed clamp and the movable clamp each have a holding groove (holding surface) formed in a semicircular shape. The tube is held between both clamps by being fitted into the holding grooves of both clamps. The tube held by both clamps is pressed and tightened radially inward by the holding groove of the movable clamp when the movable clamp is pulled toward the fixed clamp by the tightening mechanism. Accordingly, the clamp jig can hold the tube such that the tube does not slip.

### CITATION LIST

### Patent Literature

PATENT LITERATURE 1: Japanese Laid-Open Patent Publication No. 2018-168947

PATENT LITERATURE 2: Japanese Laid-Open Patent Publication No. 2008-194799

### SUMMARY OF THE INVENTION

### Technical Problem

In the clamp jig, the tube needs to be strongly pressed radially inward by the tightening mechanism such that the tube does not slip on the holding grooves of both clamps. However, when the tube is strongly pressed radially inward, the entire tube tries to become bent and deformed into an elliptical shape due to the pressing force. At this time, a part of the outer circumferential surface of the tube (both end portions in the major axis direction of the ellipse) may enter the gap formed between both holding grooves, and the tube may be damaged.

The present disclosure has been made in view of such circumstances, and an object of the present disclosure is to provide a clamp jig that can inhibit a pipe from being damaged even when the pipe is pressed by a tightening mechanism to the extent that the pipe does not slip.

### Solution to Problem

(1) The present disclosure is directed to a clamp jig including: a fixed clamp having a fixed holding groove into which a part in a circumferential direction of a pipe is fitted; a movable clamp having a movable holding groove into which another part in the circumferential direction of the pipe is fitted to sandwich the pipe between the fixed holding groove and the movable holding groove, the movable clamp being provided so as to be movable with respect to the fixed clamp; and a tightening mechanism configured to pull the movable clamp toward the fixed clamp such that a bottom portion of the movable holding groove presses the pipe radially inward, in a state where the pipe is sandwiched between the fixed holding groove and the movable holding groove, wherein one holding groove out of the fixed holding groove and the movable holding groove is open at a position offset to the other holding groove side with respect to a center line of the pipe extending in a direction orthogonal to a direction in which the pipe is pressed radially inward by the tightening mechanism, in a state where the pipe is fitted into the one holding groove.

In the clamp jig of the present disclosure, the one holding groove out of the fixed holding groove and the movable holding groove is open at the position offset to the other holding groove side with respect to the center line of the pipe extending in the direction orthogonal to the direction in which the pipe is pressed radially inward by the tightening mechanism, in a state where the pipe is fitted into the one holding groove. Accordingly, even when the pipe pressed by the tightening mechanism becomes bent and deformed into an elliptical shape, both end portions in the direction of the center line (both end portions in the major axis direction of the ellipse) of the pipe come into contact with both end portions in the direction of the center line of the one holding groove. As a result, these end portions of the pipe can be inhibited from entering the gap formed between both holding grooves. Therefore, even when the pipe is pressed by the tightening mechanism to the extent that the pipe does not slip, the pipe can be inhibited from being damaged.

(2) In the clamp jig of (1) above, preferably, the one holding groove is formed in a U-shape as seen in an axial direction of the pipe fitted into the one holding groove.

In this case, it is easier to fit the pipe into the one holding groove as compared to the case where the one holding groove is formed in a C-shape as seen in the axial direction, so that the work efficiency can be improved.

(3) In the clamp jig of (1) or (2) above, preferably, the one holding groove is the fixed holding groove.

In this case, since the fixed holding groove is open at the position offset to the movable holding groove side with respect to the center line as described above, the groove depth of the fixed holding groove is deeper than the groove depth of the movable holding groove. Accordingly, when the pipe is fitted into the fixed holding groove, the pipe is held by the fixed clamp in a stable state. Therefore, it is possible to easily perform the work of moving the movable clamp to the fixed clamp side from that state to fit the pipe between both holding grooves, so that the work efficiency can be further improved.

The clamp jig of the present disclosure can inhibit a pipe from being damaged even when the pipe is pressed by the tightening mechanism to the extent that the pipe does not slip.

### BRIEF DESCRIPTION OF DRAWINGS

FIG. 1 is an axial cross-sectional view showing a pipe joint.

FIG. 2 is a perspective view showing a clamp jig according to a first embodiment of the present disclosure.

FIG. 3 is a perspective view showing a state of the clamp jig in the middle of being manipulated.

FIG. 4 is an enlarged front view of a fixed holding groove and a movable holding groove as seen from the front side, before a movable clamp is pulled toward a fixed clamp by a tightening mechanism.

FIG. 5 is an enlarged front view of a fixed holding groove and a movable holding groove of a clamp jig according to a second embodiment of the present disclosure as seen from the front.

### DETAILED DESCRIPTION

Next, preferred embodiments of the present disclosure will be described with reference to the accompanying drawings.

### Pipe Joint

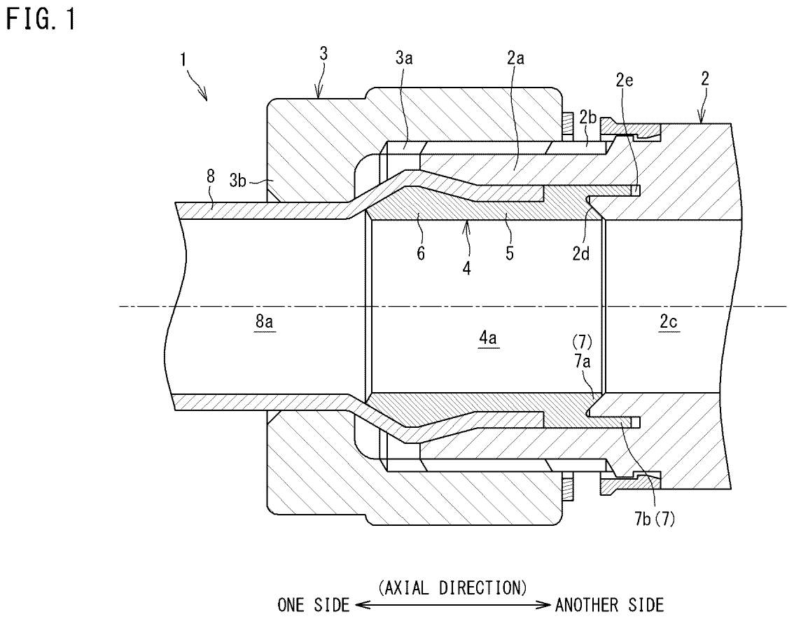

First, a pipe joint for which the clamp jig of the present disclosure is used will be described. FIG. 1 is an axial cross-sectional view of a pipe joint 1. In FIG. 1, the pipe joint 1 is used, for example, in a pipe path through which a chemical solution (fluid) used in a semiconductor manufacturing apparatus flows. The pipe joint 1 includes a joint body 2, a union nut 3, and an inner ring 4. Hereinafter, for convenience, the left side of FIG. 1 is referred to as one side in the axial direction, and the right side of FIG. 1 is referred to as another side in the axial direction.

The inner ring 4 is formed in a cylindrical shape, for example, from a synthetic resin material such as polyvinyl chloride (PVC), polypropylene (PP), polyethylene (PE), or a fluorine resin (perfluoroalkoxy alkane (PFA), polytetrafluoroethylene (PTFE), polyvinylidene fluoride (PVDF), or the like).

The inner ring 4 includes a body portion 5 formed in a cylindrical shape, a bulge portion 6 formed on the one side in the axial direction of the body portion 5, and a sealing portion 7 formed on the other side in the axial direction of the body portion 5. A fluid flow passage 4a is formed on the radially inner side of each of the body portion 5, the bulge portion 6, and the sealing portion 7 in the inner ring 4. The fluid flow passage 4a provides communication between a flow passage 8a formed inside a tube (pipe) 8 and a flow passage 2c formed inside the joint body 2. The tube 8 is composed of a flexible cylindrical hose and is formed of a synthetic resin material such as PFA.

The bulge portion 6 is formed on the one side in the axial direction of the body portion 5 so as to project toward the radially outer side. The bulge portion 6 is press-fitted into an end portion of the tube 8 to increase the diameter of the end portion of the tube 8. The sealing portion 7 has an annular primary sealing portion 7a and a cylindrical secondary sealing portion 7b.

The primary sealing portion 7a is formed so as to project from the radially inner side of another end portion in the axial direction of the body portion 5 toward the other side in the axial direction. The outer circumferential surface of the primary sealing portion 7a is formed such that the diameter thereof gradually decreases from one end in the axial direction thereof toward the other end in the axial direction thereof. The primary sealing portion 7a is press-fitted into a primary sealing groove 2d (described later) of the joint body 2. The secondary sealing portion 7b is formed so as to project from the radially outer side of the other end portion in the axial direction of the body portion 5 toward the other side in the axial direction. The secondary sealing portion 7b is press-fitted into a secondary sealing groove 2e (described later) of the joint body 2.

The joint body 2 is formed in a cylindrical shape, for example, from a synthetic resin material such as PVC, PP, PE, or a fluorine resin (PFA, PTFE, or the like). The inner diameter of the joint body 2 is substantially the same as the inner diameter of the inner ring 4 such that the movement of the chemical solution is not hindered. A receiving portion 2a is formed at one end portion in the axial direction of the joint body 2. The sealing portion 7 (end portion on the other side in the axial direction) of the inner ring 4 in which the bulge portion 6 is press-fitted into the end portion of the tube 8 is press-fitted into the inner circumference of the receiving portion 2a. Accordingly, the one end portion in the axial direction of the joint body 2 is mounted on the outer circumference of the end portion of the tube 8. An external thread portion 2b is formed on the outer circumference of the receiving portion 2a.

The joint body 2 has the annular primary sealing groove 2d and the annular secondary sealing groove 2e which are formed on the radially inner side with respect to the receiving portion 2a. The primary sealing groove 2d is formed on the radially inner side of the joint body 2 in a tapered shape that is cut such that the diameter thereof gradually decreases from one end in the axial direction thereof toward the other end in the axial direction thereof. The secondary sealing groove 2e is formed on the radially outer side with respect to the primary sealing groove 2d in the joint body 2.

The union nut 3 is formed in a cylindrical shape, for example, from a synthetic resin material such as PVC, PP, PE, or a fluorine resin (PFA, PTFE, or the like). The union nut 3 has an internal thread portion 3a formed on the inner circumference thereof on the other side in the axial direction, and a pressing portion 3b formed on the one side in the axial direction thereof so as to project toward the radially inner side. The internal thread portion 3a is screwed onto the external thread portion 2b of the joint body 2. By the screwing, the union nut 3 is attached to the joint body 2. In this case, another end portion in the axial direction of the pressing portion 3b presses the outer circumferential surface of the tube 8 whose diameter is increased by the bulge portion 6 of the inner ring 4.

With the above configuration, when the internal thread portion 3a of the union nut 3 is screwed onto the external thread portion 2b of the joint body 2, the primary sealing portion 7a and the secondary sealing portion 7b of the inner ring 4 are press-fitted into the primary sealing groove 2d and the secondary sealing groove 2e of the joint body 2, respectively. Accordingly, sealing performance at the connection portion between the inner ring 4 and the joint body 2 can be ensured. In addition, by the pressing portion 3b of the union nut 3 pressing the outer circumferential surface of the tube 8 whose diameter has been increased, toward the other side in the axial direction, the tube 8 can be prevented from being pulled out of the pipe joint 1.

### First Embodiment

### <Entire Configuration of Clamp Jig>

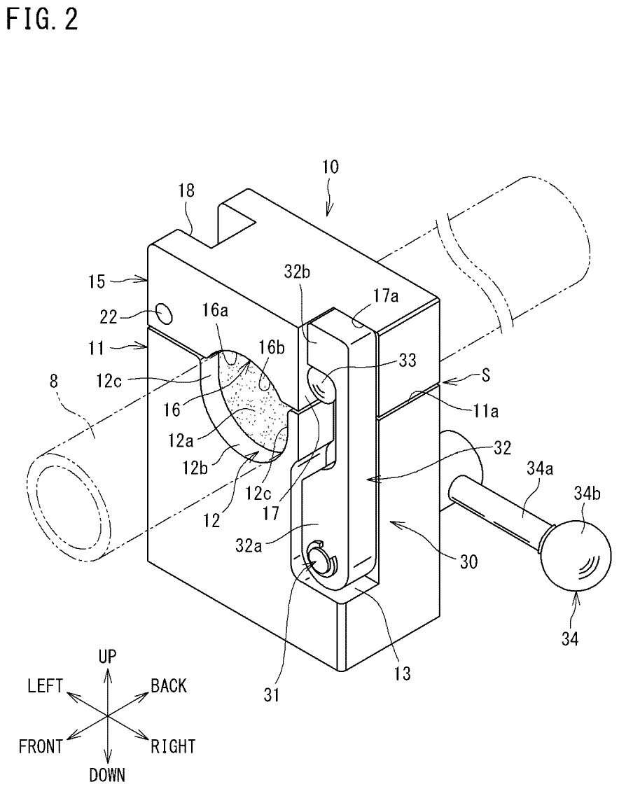

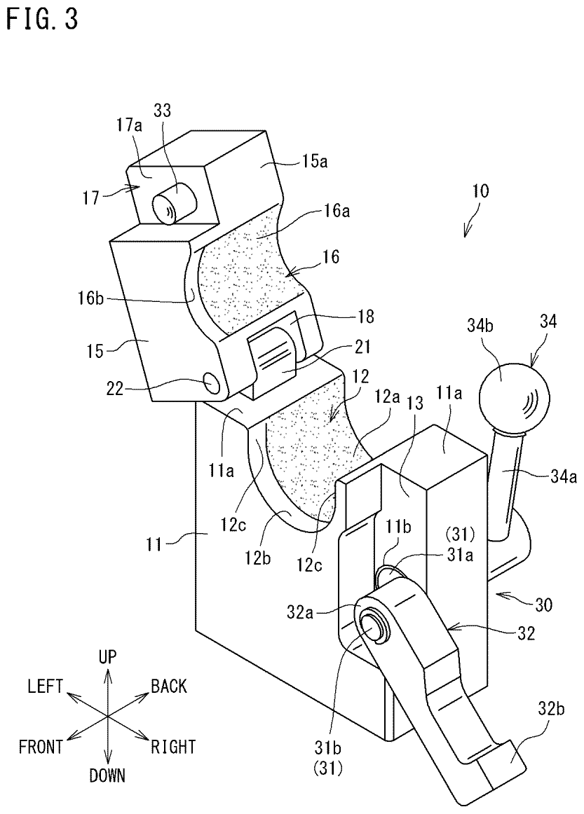

FIG. 2 is a perspective view showing a clamp jig 10 according to a first embodiment of the present disclosure. FIG. 3 is a perspective view showing a state of the clamp jig 10 in the middle of being manipulated. In FIG. 2 and FIG. 3, the clamp jig 10 is a jig for holding the tube 8 such that the tube 8 does not slip when press-fitting the inner ring 4 of the pipe joint 1 into the end portion of the tube 8. In the following, directions such as “up”, “down”, “right”, “left”, “front”, and “back” mean directions shown in FIG. 2.

The clamp jig 10 includes a fixed clamp 11, a movable clamp 15, and a tightening mechanism 30. The fixed clamp 11 is formed, for example, in substantially a rectangular parallelepiped shape. The fixed clamp 11 has a fixed holding groove 12 and a cut portion 13. The cut portion 13 is formed in the right front corner of the fixed clamp 11. The cut portion 13 is formed from the middle of the lower side of the corner to an end surface 11a.

The fixed holding groove 12 is formed at substantially a center portion in the right-left direction of the end surface 11a on the upper side of the fixed clamp 11. A part in the circumferential direction (lower part in FIG. 2) of the tube 8 is fitted into the fixed holding groove 12. The surface of the fixed holding groove 12 has a rough surface portion 12a formed by blasting in order to inhibit the tube 8 from slipping on this surface.

As with the fixed clamp 11, the movable clamp 15 is formed, for example, in substantially a rectangular parallelepiped shape. The movable clamp 15 is formed so as to be shorter in the up-down direction than the fixed clamp 11. The movable clamp 15 has a movable holding groove 16, a cut portion 17, and a recess 18. The cut portion 17 is formed in the right front corner of the movable clamp 15. The cut portion 17 is formed over the entire length in the up-down direction of the movable clamp 15. In the state shown in FIG. 2, the cut portion 17 communicates with the cut portion 13 of the fixed clamp 11. The recess 18 is formed on the left side surface of the movable clamp 15. The recess 18 is formed over the entire length in the up-down direction of the movable clamp 15.

The movable holding groove 16 is formed at substantially a center portion in the right-left direction of an end surface 15a on the lower side of the movable clamp 15. In the state shown in FIG. 2, the movable holding groove 16 is positioned so as to face the fixed holding groove 12. Another part in the circumferential direction (upper part in FIG. 2) of the tube 8 is fitted into the movable holding groove 16. Accordingly, the tube 8 can be sandwiched between the fixed holding groove 12 and the movable holding groove 16 in the up-down direction. The surface of the movable holding groove 16 has a rough surface portion 16a formed by blasting in order to inhibit the tube 8 from slipping on this surface.

The movable clamp 15 is provided so as to be movable with respect to the fixed clamp 11. Specifically, a bracket 21 is placed in the recess 18 of the movable clamp 15 and is fixed to the left side of the end surface 11a of the fixed clamp 11. A left lower end portion of the movable clamp 15 is rotatably supported by the bracket 21 via a pin 22 extending in the front-back direction. Accordingly, the movable clamp 15 of the present embodiment is provided so as to be rotatable with respect to the fixed clamp 11.

The movable clamp 15 is rotatable between a holding attitude in which the tube 8 is sandwiched between the fixed holding groove 12 and the movable holding groove 16 (attitude shown in FIG. 2) and a retreat attitude in which the movable holding groove 16 is separated from the tube 8 (attitude shown in FIG. 3). When the movable clamp 15 is in the holding attitude, a slight gap S is formed between the end surface 15a on the lower side of the movable clamp 15 and the end surface 11a on the upper side of the fixed clamp 11.

### <Tightening Mechanism>

The tightening mechanism 30 is a mechanism that pulls the movable clamp 15 in the holding attitude toward the fixed clamp 11. The tightening mechanism 30 includes an eccentric cam 31, a hook 32, an engagement pin 33, and an operation portion 34. The eccentric cam 31 is provided in the cut portion 13 of the fixed clamp 11. The eccentric cam 31 has a cam shaft 31a and a cam portion 31b integrally provided with the cam shaft 31a. The cam shaft 31a is inserted into a through hole 11b formed in the fixed clamp 11 so as to extend therethrough in the front-back direction, and is supported so as to be rotatable with respect to the fixed clamp 11. The cam portion 31b is fixed eccentrically to the cam shaft 31a at a front end portion of the cam shaft 31a. Accordingly, when the cam shaft 31a rotates, the cam portion 31b rotates eccentrically with respect to the cam shaft 31a.

The hook 32 is connected to the eccentric cam 31 on the front side of the fixed clamp 11. The hook 32 has a support portion 32a rotatably connected to the cam portion 31b and an engagement portion 32b integrally provided with the support portion 32a. The support portion 32a extends from the cam portion 31b toward the radially outer side of the cam shaft 31a. The engagement portion 32b extends from the distal end of the support portion 32a further toward the radially outer side. The hook 32 is rotatable in the up-down direction with respect to the cam portion 31b.

The engagement pin 33 is fixed to the right side of the movable clamp 15. Specifically, the engagement pin 33 is fixed to a side surface 17a on the back side of the cut portion 17 of the movable clamp 15 and projects frontward from the side surface 17a. The engagement pin 33 is formed, for example, in a columnar shape.

When the hook 32 is rotated upward, the engagement portion 32b is brought into engagement with the engagement pin 33 (see FIG. 2). When the hook 32 is rotated downward from this state, the engagement portion 32b is separated from the engagement pin 33, thereby disengaging the engagement portion 32b from the engagement pin 33 (see FIG. 3). Therefore, the hook 32 is configured to rotate up and down between an engagement attitude in which the engagement portion 32b is engaged with the engagement pin 33 (attitude shown in FIG. 2) and a disengagement attitude in which the engagement portion 32b is disengaged from the engagement pin 33 (attitude shown in FIG. 3).

The operation portion 34 is rotationally operated when the hook 32 is in the engagement attitude. The operation portion 34 is connected to the eccentric cam 31 on the back side of the fixed clamp 11. The operation portion 34 has a lever portion 34a and a grip portion 34b. One end portion of the lever portion 34a is integrally connected to the cam shaft 31a.

The grip portion 34b is integrally fixed to another end portion of the lever portion 34a. The operator can rotationally operate the operation portion 34 by gripping the grip portion 34b. The operation portion 34 is configured to rotate around the cam shaft 31a between a tightening position shown in FIG. 2 and a non-tightening position shown in FIG. 3.

When the operation portion 34 is rotationally operated from the non-tightening position to the tightening position, the cam shaft 31a rotates together with the operation portion 34, causing the cam portion 31b to rotate with respect to the support portion 32a of the hook 32. At this time, the cam portion 31b rotates eccentrically so as to press the support portion 32a of the hook 32 downward. Accordingly, the hook 32 moves downward with respect to the fixed clamp 11 while being maintained in the engagement attitude.

When the hook 32 moves downward, the movable clamp 15 in the holding attitude rotates downward within the range of the gap S and is pulled toward the fixed clamp 11. Accordingly, a bottom portion (upper portion in FIG. 2) of the movable holding groove 16 presses the outer circumferential surface of the tube 8 radially inward (downward in FIG. 2), so that the tube 8 is firmly held between the fixed holding groove 12 and the movable holding groove 16 such that the tube 8 does not slip.

### <Tube Holding Structure>

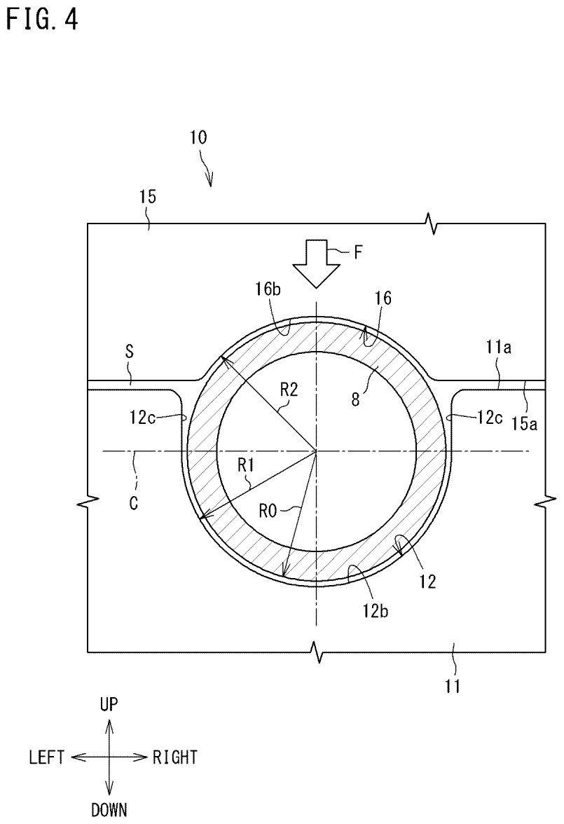

FIG. 4 is an enlarged front view of the fixed holding groove 12 and the movable holding groove 16 as seen from the front side, before the movable clamp 15 is pulled toward the fixed clamp 11 by the tightening mechanism 30 (see FIG. 2), in a state where the tube 8 is sandwiched between the fixed holding groove 12 and the movable holding groove 16. As described above, when the movable clamp 15 is pulled toward the fixed clamp 11 by the tightening mechanism 30, the bottom portion of the movable holding groove 16 presses the outer circumferential surface of the tube 8 radially inward (downward in FIG. 4). Hereinafter, the direction in which the outer circumferential surface of the tube 8 is pressed radially inward is referred to as pressing direction F.

In FIG. 4, the fixed holding groove 12 of the present embodiment is formed in a U-shape as seen in the axial direction of the tube 8 fitted into the fixed holding groove 12 (a direction perpendicular to the drawing sheet of FIG. 4). The fixed holding groove 12 has an arc surface 12b and a pair of sidewall surfaces 12c. The arc surface 12b is formed in a semicircular shape. A radius of curvature R1 of the arc surface 12b is the same as or slightly smaller than a radius R0 of the outer circumferential surface of the tube 8. In FIG. 4, for convenience, the radius of curvature R1 of the arc surface 12b is illustrated as slightly larger than the radius R0 (the same applies to a radius of curvature R2 described later).

The sidewall surfaces 12c are formed so as to extend in a straight manner from both ends, respectively, of the arc surface 12b in a direction opposite to the pressing direction F (upward in FIG. 4). Accordingly, the fixed holding groove 12 is open at a position offset (displaced) to the movable holding groove 16 side with respect to a center line C of the tube 8 extending in a direction orthogonal to the pressing direction F (in the right-left direction in FIG. 4). Therefore, in the present embodiment, the groove depth of the fixed holding groove 12 is deeper than the groove depth of the movable holding groove 16.

As shown in FIG. 4, when the movable clamp 15 is in the holding attitude, the movable holding groove 16 is positioned above the fixed holding groove 12 via the gap S. The movable holding groove 16 of the present embodiment is formed in an arc shape as seen in the axial direction of the tube 8 fitted into the fixed holding groove 12. The movable holding groove 16 has an arc surface 16b formed over the entire groove. When the movable clamp 15 is in the holding attitude, the arc surface 16b of the movable holding groove 16 is positioned concentrically with the arc surface 12b of the fixed holding groove 12. The radius of curvature R2 of the arc surface 16b of the movable holding groove 16 is the same as the radius of curvature R1 of the arc surface 12b of the fixed holding groove 12. It is preferable that the groove depth of the fixed holding groove 12 is set to be 75% of the radius of curvature R1 (R2), and the groove depth of the movable holding groove 16 is set to be 25% of the radius of curvature R1 (R2).

### <Method for Manipulating Clamp Jig>

Next, a method for manipulating the clamp jig 10 will be described. Here, the description will begin with the state of the clamp jig 10 shown in FIG. 3, that is, a state where the movable clamp 15 is in the retreat attitude, the hook 32 is in the disengagement attitude, and the operation portion 34 is in the non-tightening position. First, the operator fits the tube 8 into the fixed holding groove 12 of the fixed clamp 11 and rotates the movable clamp 15 from the retreat attitude to the holding attitude (see FIG. 2). Accordingly, the tube 8 is sandwiched between the fixed holding groove 12 and the movable holding groove 16 (see FIG. 4).

Next, the operator rotates the hook 32 from the disengagement attitude to the engagement attitude to bring the engagement portion 32b of the hook 32 into engagement with the engagement pin 33 on the movable clamp 15 side (see FIG. 2). Next, the operator rotationally operates the operation portion 34 from the non-tightening position to the tightening position to pull the movable clamp 15 in the holding attitude toward the fixed clamp 11. Accordingly, the bottom portion of the movable holding groove 16 presses the outer circumferential surface of the tube 8 radially inward (in the pressing direction F in FIG. 4), so that the tube 8 is firmly held between the fixed holding groove 12 and the movable holding groove 16 such that the tube 8 does not slip.

When the bottom portion of the movable holding groove 16 presses the outer circumferential surface of the tube 8, the tube 8 becomes bent and deformed into an elliptical shape so as to become longer in the direction of the center line C (see FIG. 4) orthogonal to the pressing direction F (in the right-left direction). Therefore, due to this bending deformation, of both end portions in the right-left direction (both end portions in the major axis direction of the ellipse) of the outer circumferential surface of the tube 8, portions below the center line C mainly come into contact with the arc surface 12b of the fixed holding groove 12, and portions above the center line C mainly come into contact with the sidewall surfaces 12c of the fixed holding groove 12.

### <Advantageous Effects>

In the clamp jig 10 of the present embodiment, in a state where the tube 8 is fitted into the fixed holding groove 12 of the fixed clamp 11, the fixed holding groove 12 is open at the position offset to the movable holding groove 16 side of the movable clamp 15 with respect to the center line C of the tube 8 extending in the right-left direction. Accordingly, even when the tube 8 pressed by the tightening mechanism 30 becomes bent and deformed into an elliptical shape so as to become longer in the right-left direction, both end portions in the right-left direction of the outer circumferential surface of the tube 8 come into contact with both side portions (both sidewall surfaces 12c) of the fixed holding groove 12. As a result, these end portions of the tube 8 can be inhibited from entering the gap S between the holding grooves 12 and 16 on the upper and lower sides. Therefore, even when the tube 8 is pressed by the tightening mechanism 30 to the extent that the tube 8 does not slip, the tube 8 can be inhibited from being damaged.

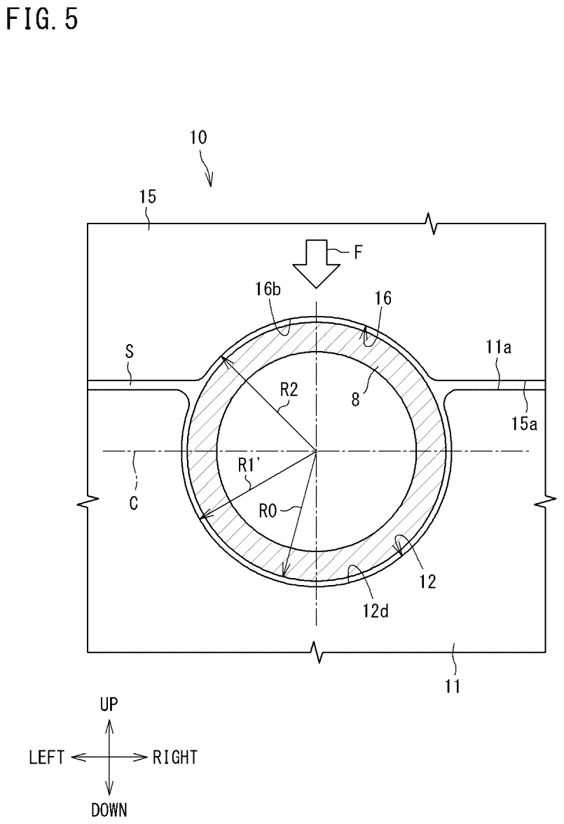

The fixed holding groove 12 is formed in a U-shape. Accordingly, it is easier to fit the tube 8 through the upper opening of the fixed holding groove 12 as compared to the case (see FIG. 5) where the fixed holding groove 12 is formed in a C-shape, so that the work efficiency can be improved. In addition, the surface of the fixed holding groove 12 can be easily blasted, so that the fixed clamp 11 can also be easily machined.

Since the opening of the fixed holding groove 12 is offset as described above, the groove depth of the fixed holding groove 12 is deeper than the groove depth of the movable holding groove 16. Accordingly, when the tube 8 is fitted into the fixed holding groove 12, the tube 8 is held by the fixed clamp 11 in a stable state. Therefore, it is possible to easily perform the work of rotating the movable clamp 15 to the holding attitude from that state to sandwich the tube 8 between the holding grooves 12 and 16 on the upper and lower sides, so that the work efficiency can be further improved.

### Second Embodiment

FIG. 5 is an enlarged front view of a fixed holding groove 12 and a movable holding groove 16 of a clamp jig 10 according to a second embodiment of the present disclosure. FIG. 5 shows the same state as in FIG. 4. In the second embodiment, the shape of the fixed holding groove 12 is different from that in the first embodiment.

The fixed holding groove 12 of the present embodiment is formed in a C-shape in which the movable holding groove 16 side is open, as seen in the axial direction of the tube 8 fitted into the fixed holding groove 12 (a direction perpendicular to the drawing sheet of FIG. 5). The fixed holding groove 12 has an arc surface 12d formed over the entire groove.

A radius of curvature R1′ of the arc surface 12d is the same as or slightly smaller than the radius R0 of the outer circumferential surface of the tube 8. In addition, the radius of curvature R1′ of the arc surface 12d is the same as the radius of curvature R2 of the arc surface 16b of the movable holding groove 16. In FIG. 5, for convenience, the radius of curvature R1′ of the arc surface 12d is illustrated as slightly larger than the radius R0 (the same applies to the radius of curvature R2).

When the bottom portion of the movable holding groove 16 presses the outer circumferential surface of the tube 8 by the tightening mechanism 30 (see FIG. 2), the tube 8 becomes bent and deformed into an elliptical shape so as to become longer in the direction of the center line C orthogonal to the pressing direction F (in the right-left direction) as in the first embodiment. Therefore, due to this bending deformation, both end portions in the right-left direction (both end portions in the major axis direction of the ellipse) of the outer circumferential surface of the tube 8 come into contact with both side portions of the fixed holding groove 12 (both end portions in the circumferential direction of the arc surface 12d). The other components of the present embodiment are the same as in the first embodiment, and thus are designated by the same reference signs, and the description thereof is omitted.

In the clamp jig 10 of the present embodiment as well, even if the tube 8 pressed by the tightening mechanism 30 becomes bent and deformed into an elliptical shape so as to become longer in the right-left direction, both end portions in the right-left direction of the outer circumferential surface of the tube 8 come into contact with both side portions of the fixed holding groove 12. As a result, these end portions of the tube 8 can be inhibited from entering the gap S between the holding grooves 12 and 16 on the upper and lower sides. Therefore, even if the tube 8 is pressed by the tightening mechanism 30 to the extent that the tube 8 does not slip, the tube 8 can be inhibited from being damaged.

Since the fixed holding groove 12 is formed in a C-shape, the tube 8 fitted from the fixed holding groove 12 is less likely to be pulled out of the opening of the fixed holding groove 12. Therefore, it is possible to easily perform the work of rotating the movable clamp 15 to the holding attitude from that state to sandwich the tube 8 between the holding grooves 12 and 16 on the upper and lower sides, so that the work efficiency can be improved.

In the present embodiment as well, since the groove depth of the fixed holding groove 12 is deeper than the groove depth of the movable holding groove 16, when the tube 8 is fitted into the fixed holding groove 12, the tube 8 is held by the fixed clamp 11 in a more stable state. Therefore, it is possible to more easily perform the work of rotating the movable clamp 15 to the holding attitude to sandwich the tube 8 between the holding grooves 12 and 16 on the upper and lower sides, so that the work efficiency can be further improved.

### Others

The movable clamp 15 of each embodiment above is provided so as to be rotatable with respect to the fixed clamp 11, but is not limited thereto. For example, the movable clamp 15 may be provided so as to be slidable in the up-down direction in FIG. 2 with respect to the fixed clamp 11 via a slide rail or the like. In addition, the clamp jig 10 may also be configured such that the movable clamp 15 can be separated from the fixed clamp 11 without providing a member (the bracket 21, a slide rail, etc.) connecting the fixed clamp 11 and the movable clamp 15.

In each embodiment above, when the movable clamp 15 is in the holding attitude, the arc surface 16b of the movable holding groove 16 is positioned concentrically with the arc surface 12b (or 12d) of the fixed holding groove 12, but the center of the arc surface 16b may be positioned so as to be slightly lower in FIG. 4 (or FIG. 5) than the center of the arc surface 12b (or 12d). In that case, when the movable clamp 15 is in the holding attitude, the gap between the holding grooves 12 and 16 on the upper and lower sides becomes narrower, so that the tube 8 can be further firmly held between both holding grooves 12 and 16.

In each embodiment above, the radius of curvature R2 of the arc surface 16b of the movable holding groove 16 is the same as the radius of curvature R1 (or R1′) of the arc surface 12b (or 12d) of the fixed holding groove 12, but may be different from the radius of curvature R1 (or R1′). For example, the radius of curvature R2 may be slightly smaller than the radius of curvature R1 (or R1′). In that case as well, when the movable clamp 15 is in the holding attitude, the gap between the holding grooves 12 and 16 on the upper and lower sides becomes narrower, so that the tube 8 can be further firmly held between both holding grooves 12 and 16.

In each embodiment above, the fixed holding groove 12 is open at the position offset to the movable holding groove 16 side with respect to the center line C of the tube 8, but the movable holding groove 16 may be open at a position offset to the fixed holding groove 12 side with respect to the center line C of the tube 8. In that case, it is needless to say that the groove depth of the movable holding groove 16 is deeper than the groove depth of the fixed holding groove 12.

The surfaces of the holding grooves 12 and 16 have the rough surface portions 12a and 16a formed by blasting, respectively, but a non-slip material such as synthetic rubber may be attached to the surfaces of the holding grooves 12 and 16. In addition, the rough surface portions 12a and 16a do not have to be formed in the surfaces of the holding grooves 12 and 16, respectively, and a non-slip material does not have to be attached thereto. That is, the surfaces of the holding grooves 12 and 16 may each have a machining-level surface roughness.

The embodiments disclosed herein are merely illustrative in all aspects and should not be recognized as being restrictive. The scope of the present invention is defined by the scope of the claims rather than the meaning described above, and is intended to include meaning equivalent to the scope of the claims and all modifications within the scope.

### REFERENCE SIGNS LIST

8 tube (pipe)
10 clamp jig
11 fixed clamp
12 fixed holding groove
15 movable clamp
16 movable holding groove
30 tightening mechanism
C center line
F pressing direction (direction to be pressed)

1. A clamp jig comprising:
a fixed clamp having a fixed holding groove into which a part in a circumferential direction of a pipe is fitted;
a movable clamp having a movable holding groove into which another part in the circumferential direction of the pipe is fitted to sandwich the pipe between the fixed holding groove and the movable holding groove, the movable clamp being provided so as to be movable with respect to the fixed clamp; and
a tightening mechanism configured to pull the movable clamp toward the fixed clamp such that a bottom portion of the movable holding groove presses the pipe radially inward, in a state where the pipe is sandwiched between the fixed holding groove and the movable holding groove, wherein
one holding groove out of the fixed holding groove and the movable holding groove is open at a position offset toward the other holding groove with respect to a center line of the pipe extending in a direction orthogonal to a direction in which the pipe is pressed radially inward by the tightening mechanism, in a state where the pipe is fitted into the one holding groove.

2. The clamp jig according to claim 1, wherein the one holding groove is formed in a U-shape as seen in an axial direction of the pipe fitted into the one holding groove.

3. The clamp jig according to claim 1, wherein the one holding groove is the fixed holding groove.
